(19) United States
(12) Patent Application Publication
(10) Pub. No.: US 2005/0208949 A1
(43) Pub. Date: Sep. 22, 2005

(54) Centralized channel assignment and routing algorithms for multi-channel wireless mesh networks

(76) Inventor: Tzi-cker Chiueh, East Setauket, NY (US)

Correspondence Address: F. CHAU & ASSOCIATES, LLC, 130 WOODBURY ROAD, WOODBURY, NY, 11797, US

(21) Appl. No.: 11/057,577

(22) Filed: Feb. 14, 2005

Related U.S. Application Data
(60) Provisional application No. 60/544,177, filed on Feb. 12, 2004.

(51) Int. Cl. H04Q 7/20

(52) U.S. Cl. 455/452.2

(57) ABSTRACT

A method for channel assignment in a wireless network includes determining a channel/route configuration comprising channel assignments and routing information for a plurality of nodes of the wireless network providing a desired initial network cross-section throughput, determining a link capacity for each link between a plurality of node pairs of the plurality of nodes, and modifying the route information of the channel/route configuration according to the link capacity.

This application claims priority to U.S. Provisional Application No. 60/544,177, filed on Feb. 12, 2004, the disclosure of which is herein incorporated by reference in its entirety.

### BACKGROUND OF THE INVENTION

1. Technical Field

The present invention relates to wireless networks, and more particularly to a system and method for channel assignment and routing for a wireless mesh network.

2. Discussion of Related Art

Despite significant advances in physical layer technologies, wireless local area networks (WLAN) do not offer the same level of sustained bandwidth as wired networks. The advertised 54 Mbps bandwidth for IEEE 802.11a/g based hardware is the peak link-level data rate. When all the overheads—MAC contention, 802.11 headers, 802.11 ACK, packet errors—are accounted for, the actual goodput available to applications is about halved. In addition, the maximum link-layer data rate falls quickly with increasing distance between the transmitter and receiver. The bandwidth problem is further aggravated for multi-hop ad hoc networks because of interference from adjacent hops in the same path as well as from neighboring paths. FIG. 1 shows an example of such interference. Fortunately, the IEEE 802.11b/802.11g standards and IEEE 802.11a standard provide 3 and 12 non-overlapping frequency channels, respectively, that could be used simultaneously within a neighborhood. Ability to utilize multiple channels within the same network substantially increases the effective bandwidth available to wireless network nodes. Such bandwidth aggregation is routinely used when an 802.11-based WLAN operates in infrastructure mode, where traffic to and from wireless nodes is distributed among multiple interfaces of an access point or among multiple access points to avoid congestion. However, bandwidth aggregation is rarely applied to 802.11-based LANs that operate in the ad hoc mode. There have been several research efforts that aim to exploit multiple radio channels in an ad hoc network, most of them were based on proprietary MAC protocols, and therefore cannot be directly applied to wireless networks using commodity 802.11 interfaces.

A single-NIC architecture inherently limits the whole network to operate in one single channel. This is because an attempt to use multiple channels in single-NIC network disconnects the subset of nodes using one channel from other nodes that are not using the same channel (FIG. 2(a)). Cross-channel communication requires either channel-switching capability within each node, or multiple NICs per node each tuned to operate in a different channel. Channel-switching requires fine-grained synchronization among nodes as to when any node will transmit/receive over a particular channel. Such fine grained synchronization is difficult to achieve without modifying 802.11 MAC.

Several proposals have been made to modify the MAC layer to support multi-channel ad hoc networks. The approach taken by most of this body of research is to find an optimal channel for a single packet transmission, essentially avoiding interference and enabling multiple parallel transmissions in a neighborhood. Unlike in all these previous proposals, our architecture does not perform channel switching on a packet-by-packet basis; our channel assignment lasts for a longer duration, such as hours or days, and hence does not require re-synchronization of communicating network cards on a different channel for every packet. This property makes it feasible to implement our architecture using commodity 802.11 hardware. Additionally, our system takes a more global approach by adjusting channel assignments and routes based on the overall network traffic patterns.

A vast amount of research has been conducted in single-channel multi-hop routing in ad hoc networks. Several commercial as well as research projects aim to utilize Wireless Mesh Networks to provide last-mile wireless connectivity. Mesh Networks Inc's Mesh Enabled Architecture and Radiant Networks' MeshWorks are two of the recent commercial wireless mesh networks. Both of these architectures use proprietary hardware that is not compliant with 802.11 standard. Nokia's RoofTop Wireless Network is another commercial mesh network built using proprietary 2.4 GHz wireless routers. Nokia's RoofTop Network uses a common control channel and multiple data channels to reduce interference among different transmissions. Transit Access Point Network is a proposed mesh network architecture using nodes equipped with beamforming antennas. In essence, most of these wireless mesh network projects are either based on single-channel or based on proprietary modifications to 802.11 protocol to utilize multiple channels.

The multi-NIC approach has also been mentioned in some past work; the true performance potential of the multi-NIC approach has however not been discovered earlier. The use of multiple 802.11 NICs per node in an ad hoc network setting has been proposed, wherein an apriori and identical channel assignment to the NICs was assumed. The channel assignment of each node is the same—NIC-1 is assigned channel 1, NIC-2 is assigned channel-2, and so on. This approach to use multiple NICs can only yield a factor 2 of improvement using 2 NICs, as compared to a factor 8 improvement possible with our channel assignment scheme. The use of multiple NICs on each mesh node has been proposed wherein multiple NICs requires each node to have as many NICs as it has neighbors. Also required is a sufficiently large number of available channels. Essentially, none of these approaches realize the true potential of multi-NIC architecture.

A channel allocation problem also occurs in cellular networks where because of limited number, the available channels need to be re-used from cell-to-cell, while maintaining the minimum re-use distance. This leads to the problem of channel allocation where each cell needs to be assigned certain channels, based on its traffic and channels used in near-by cells. Various static and dynamic techniques have been proposed and used to solve this problem. The asymmetry of component roles and communication behaviors in cellular network makes it different from ad hoc networks. In a cellular network, all mobile devices communicate with their corresponding base stations, while the base-station to base-station communication is carried over a separate network and the cellular channel allocation does not address that issue.

Therefore, a need exists for a system and method for channel assignment and routing in wireless networks.

### SUMMARY OF THE INVENTION

According to an embodiment of the present disclosure, a method for channel assignment in a wireless network includes estimating an expected load on each link of the wireless network, each link being between a node pair in the wireless network, determining a channel assignment between each node pair in the wireless network such that a bandwidth made available to each virtual link is at least the expected load, determining an actual link capacity given the channel assignment, and modifying the channel assignment according to the actual link capacity.

The method comprises estimating a traffic load for all ingress-egress node pairs of the wireless network.

The method comprises determining a topology of the wireless network.

The method comprises determining a number of network interfaces available to each node of the wireless network.

The method comprises determining a number of non-over lapping channels.

The channel assignment between nodes binds an interface of the each node to the channel.

The method comprises determining a set of paths for each pair of communicating node in the wireless network, wherein the wireless network is a mesh network.

According to an embodiment of the present disclosure, a method for channel assignment in a wireless network includes determining a channel/route configuration comprising channel assignments and routing information for a plurality of nodes of the wireless network providing a desired initial network cross-section throughput, determining a link capacity for each link between a plurality of node pairs of the plurality of nodes, and modifying the route information of the channel/route configuration according to the link capacity.

Determining the channel/route configuration comprises determining the channel assignment for each link between node pairs, an initial channel assignment being determined without link capacity information, determining a link capacity for each link, determining the routing information according to the link capacities, outputting expected link loads for each link, and interating through the determinations of the channel assignment and routing information until link capacity is at least equal to the expect link load for each link. The initial channel assignment assumes that interfering links within a neighborhood equally split the bandwidth of a plurality of available radio channels.

Modifying the route information of the channel/route configuration according to the link capacity comprises determining routes that have a link capacity less than an expected link load, and modifying the routes that have the link capacity less than the expected link load to at least lessen the difference between the link capacity and the expected link load.

The method comprises determining a fixed routing order prior to determining a first determining a channel/route configuration. The routing order specifies that routes having a shorter hopcount between end-point nodes are modified before routes having a longer hopcount between end-point nodes.

The network cross-section throughput is a measure of goodput.

According to an embodiment of the present disclosure, a program storage device is provided readable by machine, tangibly embodying a program of instructions executable by the machine to perform method steps for channel assignment in a wireless network. The method steps include determining a channel/route configuration comprising channel assignments and routing information for a plurality of nodes of the wireless network providing a desired initial network cross-section throughput, determining a link capacity for each link between a plurality of node pairs of the plurality of nodes, and modifying the route information of the channel/route configuration according to the link capacity.

### BRIEF DESCRIPTION OF THE DRAWINGS

Preferred embodiments of the present invention will be described below in more detail, with reference to the accompanying drawings:

FIG. 1 is an illustration of intra-path and inter-path interference in a single-channel multi-hop ad hoc network;

FIG. 2A is an illustration of a single-NIC network;

FIG. 2B is an illustration of a multi-NIC network;

FIG. 3 is an illustration of a system architecture according to an embodiment of the present disclosure;

FIG. 4 is an illustration of a system implementing a neighbor partitioning method according to an embodiment of the present disclosure;

FIG. 5 is a flow chart of a method for a multi-channel mesh network architecture according to an embodiment of the present disclosure;

FIG. 6 is an illustration of a channel assignment method according to an embodiment of the present disclosure;

FIG. 7 is a flow chart of a method according to an embodiment of the present disclosure;

FIG. 8 is a graph illustrating goodput for different channel assignment methods according to an embodiment of the present disclosure;

FIG. 9 is a graph illustrating load-balanced routing for different channel assignment methods according to an embodiment of the present disclosure;

FIG. 10 is a graph illustrating a ratio of load imposed by a routing method and bandwidth assigned by a channel assignment method according to an embodiment of the present disclosure;

FIG. 11 is a graph illustrating an impact of increasing a number of channels and/or NICs per node according to an embodiment of the present disclosure;

FIG. 12 is a graph illustrating an impact of varying numbers of ingress-egress pairs on goodput according to an embodiment of the present disclosure;

FIG. 13 is a graph comparing a multi-channel network with a single-channel network according to an embodiment of the present disclosure;

FIG. 14 is a graph illustrating an impact of node failures on future channel assignment according to an embodiment of the present disclosure;

FIG. 15 is an illustration of a multi-channel testbed according to an embodiment of the present disclosure; and

FIG. 16 a diagram of a constructed graph for an instance of multiple subset sum problem.

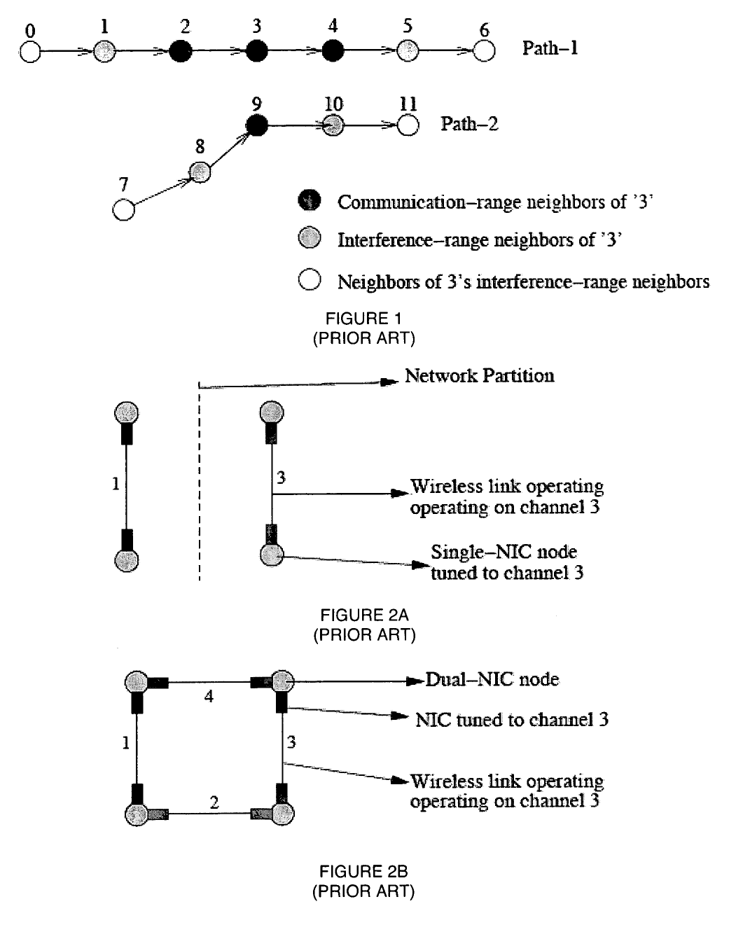

### DETAILED DECRISPTION OF PREFERRED EMBODIMENTS

According to an embodiment of the present disclosure, an architecture uses multiple frequency channels in an ad hoc network. Nodes of the network are equipped with multiple NICs, and channel assignment and routing methods. The architecture is illustrated for 802.11-based networks, and needs only system software modification.

Cross-channel communication is enabled by equipping each node with multiple 802.11 commodity NICs, each operating in a different channel (FIG. 2(b)). For two nodes to communicate with each other, their interfaces need to be assigned to a common channel. However, as more interfaces within an interference range are assigned to the same radio channel, the effective bandwidth available to each interface decreases. Therefore, a channel assignment method balances between the goals of maintaining connectivity and increasing aggregate bandwidth. The routing strategy in the network determines the load on each 802.11 interface, and in turn affects the bandwidth needs and thus the channel assignment of each interface.

A full multi-channel wireless mesh network architecture uses topology discovery, traffic profiling, channel assignment, and routing. According to an embodiment of the present disclosure, methods for channel assignment and its integration with routing are provided. Topology discovery and traffic profiling techniques are well known in the art.

According to an embodiment of the present disclosure channel assignment and bandwidth allocation methods achieve multi-channel wireless mesh networks. A method referred to as Neighbor Partitioning Scheme performs channel assignment based only on network topology. A method referred to as Load-Aware Channel Assignment exploits traffic load information. Using two NICs per node, the methods improve the network cross-section goodput by factors of up to three and eight, respectively.

Although each two-NIC node can only operate on two channels, the overall network can utilize additional channels (FIG. 2(b)). This breaks each collision domain into multiple collision domains each operating on a different frequency channel. This is a reason for non-linear improvement (eight times) in throughput with respect to increase in number of NICs per node (from one to two).

For wireless mesh networks where the bandwidth issue is most limiting, static nodes form a multihop backbone of a large wireless access network that provides connectivity to end-users' mobile terminals. The network nodes cooperate with each other to relay data traffic to its destinations. Wireless mesh networks are gaining significant momentum as an inexpensive solution to provide last-mile connectivity to the Internet. Some of the nodes may be provided with wired connectivity to the Internet, while the rest of the nodes access the Internet through these wire-connected nodes by forming a multi-hop wireless mesh network with them. As deployment and maintenance of wired infrastructure is a major cost component in providing ubiquitous high-speed wireless Internet access, use of mesh network on the last-hop brings down the overall ISP costs. For similar reasons, wireless mesh network can be an attractive alternative even to wired broadband technologies such as DSL/cable modem.

Wireless mesh networks can also serve as enterprise-scale wireless backbones where access points inter-connect wirelessly to form a connectivity mesh. Many of today's enterprise wireless LAN deployment is only limited to the access network role, where a comprehensive wired backbone network is still needed to relay the aggregated traffic generated from or destined towards these wireless LAN access points. Use of wireless mesh backbone network effectively eliminates this wiring overhead and enables truly wireless enterprises.

The high bandwidth needs of wireless mesh networks in each of these application domains suggests that bandwidth aggregation technique should be applied whenever possible. For bandwidth allocation purposes, the nodes in the network are not mobile. The network topology can still change because of occasional node failures/maintenance, and joining of new nodes. A multi-channel architecture according to an embodiment of the present disclosure can accommodate both of these possibilities. Further, the traffic characteristics, being aggregated from a large number of end-user traffic flows, do not change frequently. This permits network optimization based on measured traffic profiles over a time scale of hours or days, rather than seconds or minutes. It is assumed that such traffic profile information may be obtained through measurements and/or provisioning, and be used to modify channel assignment and routing decisions on a periodic basis.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

IEEE 802.11 Wireless LAN standards allow multiple non-overlapping frequency channels to be used simultaneously to increase the aggregate bandwidth available to end-users. According to an embodiment of the present disclosure, a multi-channel multi-hop wireless ad-hoc network architectures may be built using standard 802.11 hardware by equipping each node with multiple network interface cards (NICs) operating on different channels. Wireless mesh networks may serve as the backbone for relaying end-user traffic from wireless access points to the wired network. Exploiting multiple channels is particularly appealing in wireless mesh networks because of their high capacity requirements to support backbone traffic. To reap the performance potential of this architecture, a set of centralized channel assignment, bandwidth allocation, and routing methods may be implemented in multi-channel wireless mesh networks. A detailed performance evaluation shows that with intelligent channel and bandwidth assignment, equipping every wireless mesh network node with just two NICs operating on different channels can increase the total network goodput by a factor of up to eight compared with a single-channel ad hoc network architecture.

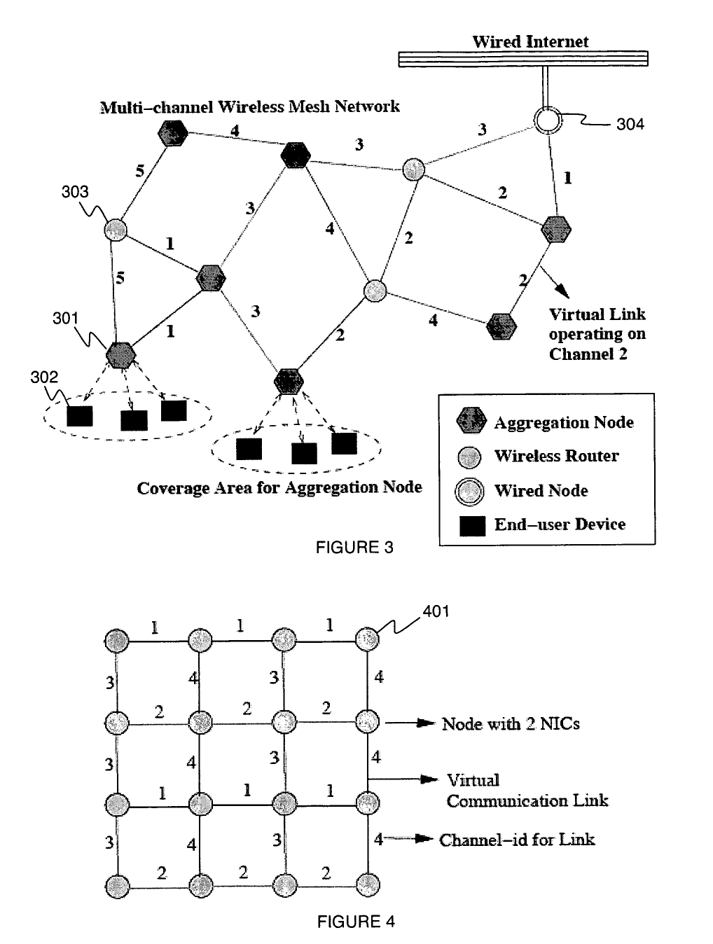

A multi-channel wireless mesh network architecture according to an embodiment of the present disclosure, and as illustrated in FIG. 3, includes static traffic aggregation nodes, e.g., 301, similar to wireless LAN access points. Each traffic aggregation node provides network connectivity to end-user mobile wireless devices, e.g., 302, within its coverage area. In turn, these static nodes form a multi-hop ad hoc network among themselves to relay traffic to and from end-user devices. Not all nodes have the aggregation capability. Some nodes in the mesh network work as pure routers, e.g., 303, while other nodes, e.g., 304, serve as gateways to the wired Internet.

Each node in a multi-channel wireless mesh network is equipped with multiple NICs, each of which is tuned to a particular radio channel for a relatively long period of time, such as hours or days. The NICs may be 802.11-compliant or adhere to another appropriate network protocol. For direct communication, two nodes need to be within communication/hearing range of each other, and need to have a common channel assigned to them. Additionally, a pair of nodes using a same channel that is within sense/interference range interferes with each other's communication, even if they cannot directly communicate. Node pairs using different channels can communicate simultaneously without interference. For example, in FIG. 3, each node is equipped with two NICs. Virtual links are shown between the nodes depicting direct communication between them; there may be no physical links between them. The radio channel used by a virtual link between a pair of nodes is shown as the number labeled on the edge. This example network uses five distinct frequency channels. Note that each mobile node has only one NIC, and the communication between mobile nodes and aggregation nodes is based on the standard IEEE 802.11 infrastructure mode operation.

Given the placement of wireless mesh network nodes and a traffic profile that describes the traffic load between each pair of nodes, the design problems include how to assign a radio channel to each 802.11 interface, and how to route traffic between all pairs of nodes, in such a way that the total goodput of the wireless mesh network is maximized.

A goal of channel assignment in a multi-channel wireless mesh network is to bind each network interface to a radio channel in such a way that the available bandwidth on each virtual link is proportional to its expected load. A node needs to share a common channel with each of its communication-range neighbors with which it wants to communicate. To reduce interference a node should not have too many common channels with any single neighbor. Each collision domain is broken into as many channels as possible while maintaining the needed connectivity among neighboring nodes.

The channel assignment method in a multi-channel wireless mesh network architecture according to an embodiment of the present disclosure can be divided into a neighbor-to-interface binding method and an interface-to-channel binding method. Neighbor-to-interface binding determines through which interface a node communicates with each of its neighbors. Because the number of interfaces per node is limited, each node may use one interface to communicate with multiple of its neighbors. Interface-to-channel binding determines which radio channel a network interface uses. The constraints that a channel assignment method needs to satisfy are the number of distinct channels that can be assigned to a wireless mesh network node is limited by the number of NICs on it and for two nodes involved in a virtual link that is expected to carry some traffic should be bound to a common channel. Further constraints include the sum of the expected loads on the links that interfere with one another and that are assigned to the same channel cannot exceed the channel's raw capacity, and the total number of radio channels is fixed.

A neighbor partitioning scheme starts with one node, partitions its neighbors into groups and assigns one group to each of its interfaces. Each of this node's neighbors, in turn, partitions its neighbors into groups, while maintaining the grouping done by the first node as a constraint. This process is iteratively repeated until all nodes have partitioned their neighbors. Each group can then be bound to a least-used channel in the neighborhood. Partitioning of neighbors results in a uniform channel assignment across the network. For a grid network, neighbor partitioning can be based on patterns such as shown in FIG. 4. In FIG. 4, each node, e.g., 401, has two NICs, and the resulting network uses four channels. Partitioning of neighbors may be done using randomization techniques.

Channel assignment depends on the expected load on each virtual link, which depends on routing. Given a set of communicating node pairs, the expected traffic between them, and the virtual link capacities, the routing method determines the route through the network for each communicating node pair. The resulting routes populate the routing tables of all the nodes and thus govern the path taken by future traffic. Apart from determining the traffic route for each communicating node pair, routing also plays an important role in the load balancing of the network. Load balancing helps avoid bottleneck creation in the network, and in turn increases the network resource utilization efficiency. Routing can also increase the tolerance of network against node failures by coming up with multiple node-independent routes for each pair of end-hosts. At run-time, if a node fails leading to a path failure, the affected nodes can have alternate paths to route their packets.

Traffic engineering in a backbone network maximizes overall goodput, or the number of bytes it can transport between nodes within a unit time. This enables the network to support more end-user flows, and in turn more number of users. To formalize this goal, the idea of cross-section goodput of the network may be used. The cross-section goodput of a network may be defined as:

$$X = {\sum }_{s , d} C ( s , d ) \qquad ( 1 )$$

Here, C(s,d) is the useful network bandwidth assigned between a pair of ingress-egress nodes (s,d). If the traffic profile has an expected traffic load of B(s,d) between the node pair (s,d), then only up to B(s,d) of the assigned bandwidth between the node pair (s,d) is considered useful. This criteria ensures that only the usable bandwidth of the network is counted towards its cross-section throughput, hence the term cross-section goodput. Channel assignment and routing methods maximize this cross-section goodput X.

In a given network, a virtual link is assumed to exist between any two nodes that are within communication range of each other. To maximize a network's overall goodput, the routing method needs to route traffic to balance the load on the network's virtual links or simply links to avoid bottlenecks. A wireless mesh network architecture according to an embodiment of the present disclosure offers another degree of freedom—modifying a virtual link's capacity by assigning a radio channel to the link. This is possible because the capacity of a virtual link depends on the number of other links that are within its interference range and that are using the same radio channel.

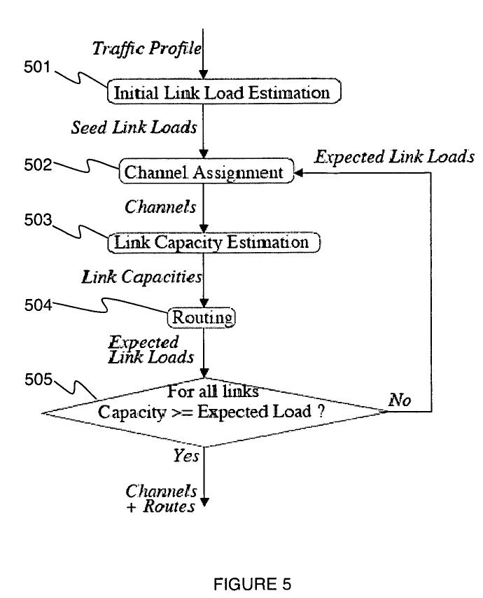

Because routing depends on the virtual links' capacity, which is determined by channel assignment, and channel assignment depends on the virtual links' expected load, which is affected by routing, there is thus a circular dependency between radio channel assignment and packet routing. Referring to FIG. 5, to break this circularity, an initial estimation of the expected load on each virtual link is determined without regard to the link capacity 501, and the estimation is iterated over channel assignment 502 and routing 504 blocks until the bandwidth allocated to each virtual link at least matches its expected load 505.

Given a set of node pairs and the expected traffic load between each node pair, the routing block 504 devises the initial routes for the node pairs. Given these initial routes for the node pairs and thus the traffic load on each virtual link, the radio channel assignment algorithm assigns a radio channel to each interface, such that the amount of bandwidth made available to each virtual link is no less than its expected load. The new channel assignment is fed back to the routing block 504 to arrive at more informed routing decisions, using actual link capacities based on current channel assignment 503. At the end of each iteration, if some of the link loads are more than their capacities 505, the method goes back to find a better channel assignment using the link-loads from previous iteration, redo the routing, and compares the new link loads with new link capacities. This iterative process continues on until no further improvement is possible. It should be noted that some problem inputs might not have corresponding feasible solutions; our goal therefore is to reduce the difference between link capacities and their expected loads as much as possible.

The inputs to the combined channel assignment and routing method shown in FIG. 5 include an estimated traffic load for all communicating node pairs, a wireless mesh network topology, and the number of 802.11 network interfaces available on each node and the number of non-overlapping radio channels. The outputs include the channel bound to each 802.11 interface and the set of paths for every communicating node pairs in the wireless mesh network.

Referring to block 501, initial link load estimation; One possibility is to assume that all interfering links within a neighborhood equally split the combined bandwidth of all radio channels. Specifically, the capacity of link l, Cₗ, is assumed to be:

$${C}_{l} = \frac{Q * {C}_{Q}}{{L}_{l}} \qquad ( 2 )$$

where Q is the number of available channels, C_{Q} is the capacity per channel, and Lₗ are the number of virtual links within the interference range of l. The equation essentially divides the aggregated channel capacities among all interfering links, without regard to number of NICs per node. Based on these virtual link capacities, the routing block 504 determines the initial routes and thus the initial link loads.

A more accurate estimate of expected link load is based on the notion of link criticality. To determine initial expected link loads 501, perfect load balancing is assumed across all acceptable paths between each communicating node pair. Let's call the number of acceptable paths between a pair of nodes (s,d), P(s,d), and the number of acceptable paths between (s,d) that pass a link l, P(s,d) . Then the expected-load on link , l,φₗ, is determined using the equation

$${ϕ}_{l} = {\sum }_{s , d} \frac{{P}_{l} ( s , d )}{P ( s , d )} * B ( s , d ) \qquad ( 3 )$$

where B(s,d) is the estimated load between the node pair (s,d) in the traffic profile. Equation 3 says that the initial expected load 501 on a link is the sum of loads from all acceptable paths, across all possible node pairs, that pass through the link. Because of the assumption of uniform multi-path routing, the load that an acceptable path between a node pair is expected to carry is the node pair's expected load divided by the total number of acceptable paths between them.

Referring to block 502, channel assignment; Given the expected load on each virtual link, a goal of channel assignment block 502 is to assign channels to network interfaces such that the resulting available bandwidth on these interfaces is at least equal to their expected traffic load. The channel assignment problem is NP-hard; a hardness proof can be found below. A greedy load-aware channel assignment method visits the virtual links in the wireless mesh network in the decreasing order of link criticality, or the expected load on a link. When a virtual link is traversed, it is assigned a channel based on the current channel assignment of the incident nodes, called node 1 and node 2 respectively in the following. The channel list of a node refers to the set of channels assigned to its virtual links. Assuming there are NICs per node, there are three possible cases—

1. Both node 1 and node 2 have fewer than members in their channel list. In this case, any channel that has the least degree of interference to the virtual link in question may be assigned.

2. One of the nodes, e.g., node 1, has members in its channel list, and the other node's channel list has fewer than members. In this case, one of the channels in node 1's channel list is chosen, assigned to the virtual link, and added it to node 2's channel list if it is not already there. The channel chosen from node 1's channel list is the one that minimizes the degree of interference for the virtual link.

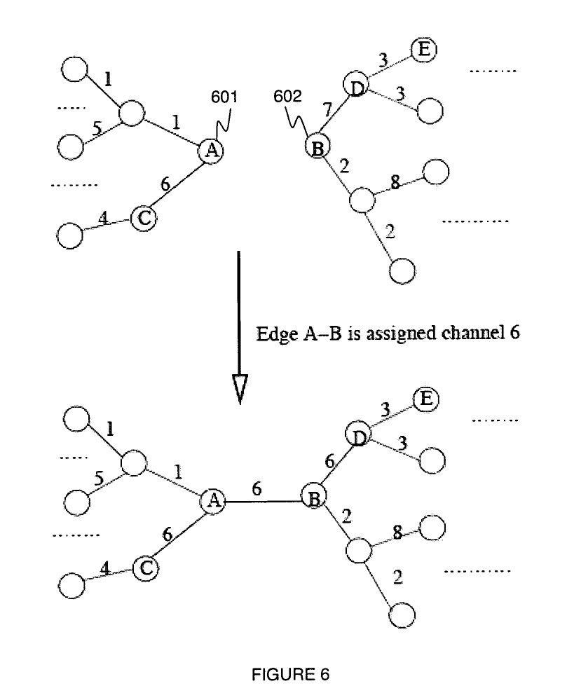

3. Both node 1 and node 2 have members in their channel lists. If there are common channels shared by node 1 and node 2, the common channel that minimizes the degree of interference is chosen and assigned to the virtual link. Otherwise, a channel from node 1 601 and a channel from node 2 601 are chosen, merged into one channel, and assigned to the virtual link (see FIG. 6). In this case, all the other instances of the two channels being merged need to be renamed into the new channel as well, e.g., the edge assigned channel 7 of node 2 602 is assigned channel 6. The choice of two channels to be merged is such that the combined degree of interference of the two channels is minimized.

The degree of interference is the sum of expected load from the virtual links in the interference region that are assigned to the same radio channel. As increasing the number of virtual links within an interference range tend to decrease the bandwidth share available to each one of them, decreasing the degree of interference of a link increases its available bandwidth. By visiting the virtual link in the decreasing order of link criticality, more loaded links are likely to be assigned to a channel with less interference, and thus given a higher capacity.

Referring to block 503, link capacity estimation; To evaluate the effectiveness of a channel assignment method 502 the capacity of each virtual link is determined, and compared against the link's expected load. The portion of channel bandwidth available to a virtual link, or the link capacity, is determined by the number of all virtual links in its interference range that are also assigned to the same channel. The exact short-term instantaneous bandwidth available to each link depends on such complex system dynamics as capture effect, coherence period, physical obstacles, stray RF (radio frequency) interferences, and distance. An approximation of the long-term bandwidth share available to a virtual link is determined. A virtual link i's capacity bwᵢ is approximated by:

$${bw}_{i} = \frac{{ϕ}_{i}}{{\sum }_{j ∈ Intf ( i )} {ϕ}_{i}} * C \qquad ( 4 )$$

where φᵢ is the expected load on link i, Intf(i) is the set of all virtual links in the interference zone of link i, and C is the sustained radio channel capacity. The rationale of Equation 4 is that when a channel is not overloaded, the channel share available to a virtual link is proportional to its expected load. The higher the expected load on a link, the more channel share it would get. The accuracy of this formula decreases as

$${\sum }_{j ∈ Intf ( i )} {ϕ}_{i}$$

approaches C.

Referring to block 504, routing methods; The load-aware channel assignment block 502 is not tied to any specific routing algorithm. It can work with different routing algorithms. For evaluation purposes, two different routing algorithms have been used—(1) shortest path routing, and (2) randomized multipath routing. The shortest path routing is based on standard Bellman-Ford algorithm with minimum hop-count metric. The shortest path here refers to the shortest “feasible” path, i.e., a path with sufficient available bandwidth and least hop-count. A multi-path routing method attempts to achieve load balancing by distributing the traffic between a pair of nodes among multiple available paths at run time. The exact set of paths between a communicating node pair is chosen randomly out of the set of available paths with sufficient bandwidth. Although in this case, the traffic between a node pair is split across multiple paths, packets associated with a network connection still follow a single path to avoid TCP re-ordering.

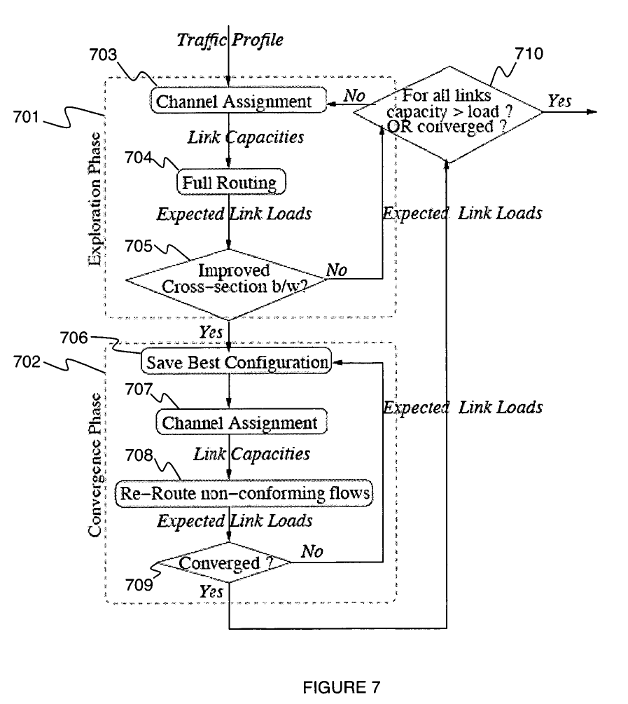

FIG. 7 depicts the iterative process of the combined channel assignment and routing methods. The initial link loads are estimated using the scheme described with respect to block 501. The channel assignment block 703 and the routing block 704 are iterated over. These iterations are the exploration phase 701. Each iteration determines a channel/route configuration that provides a better network cross-section goodput 705. A configuration determined by the exploration phase is saved 706 for use in a convergence phase 702. The convergence phase 702 is similar to the exploration phase 701, including a channel assignment block 707 similar to block 703 and a routing block 708, where the routing block 708 only re-routes the non-conforming flows, e.g., flows that have not found a path with sufficient bandwidth to meet their traffic demands. The convergence phase 702 is repeated until the cross-section goodput of the resulting network converges 709.

For both, the exploration phase 701 and the convergence phase 702, the routing order for different flows is fixed at the beginning based on the hopcount distance between the two end-points—ones with shorter hopcount distance are routed first. The particular order is chosen so as to route flows that consume lesser network resources, first. A fixed routing order almost always ensures convergence. The method iterates over both the exploration 701 and convergence 702 phases until either all node pairs are successfully routed, or no better network configuration (channel assignments and routes) is seen in several iterations 710, e.g., ten iterations.

To study the overall performance of the proposed multi-channel wireless mesh network architecture and the effectiveness of the associated channel assignment and routing algorithms, a simulation study using NS-2. NS-2 was modified to support multiple wireless cards on mobile nodes and randomized multi-path routing. In addition, to gauge the inter-channel interference that is not modeled by NS-2, a small multi-channel ad hoc network was built using 802.11b hardware and evaluated the feasibility of building a multi-interface PC-based wireless mesh network node.

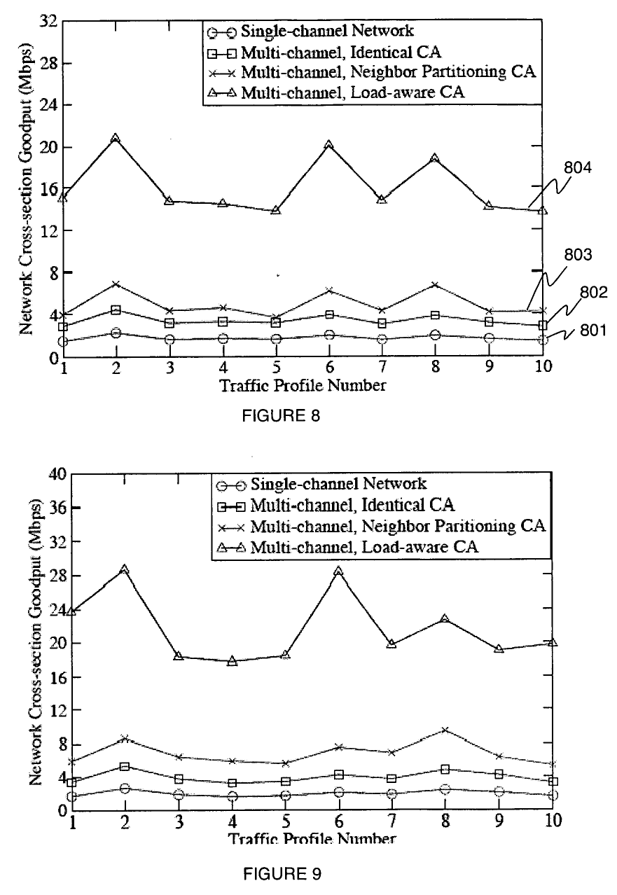

FIG. 8 presents the cross-section goodput of a 100 node square-grid network for various traffic profiles each containing 20 pairs of randomly chosen ingressegress nodes. Recall that the cross-section goodput is defined as the sum of useful bandwidth assigned between all communicating ingress-egress node pairs. For each profile, the amount of traffic between each ingress-egress node pair was chosen at random between 0 and 3 Mbps. The ratio between interference and communication range was fixed at two. Depending on its position, each node could communicate with up to four neighbors. All experiments were conducted with RTS/CTS mechanism enabled. Unless specified, the routing method used is the shortest-path routing, and initial load was determined using Equation 3.

To derive the network to saturation, the bandwidth of all the flows is proportionally varied until the network can only route 75% of the aggregate input traffic. The relative performance of different algorithms does not change for other values of saturation threshold, e.g. 100% at which it is ensured that each flow has to be assigned its needed bandwidth. The saturation threshold can also be per-flow to ensure fairness across flows, e.g., one can ensure that each flow has to be assigned at least a certain percentage of its traffic requirement. The cross-section goodput assigned by the various methods was verified using NS-2 simulations, where the traffic profile was emulated by running CBR UDP-flows between ingress-egress node pairs. The received traffic was measured on the each of the egress nodes and added together to yield the cross section goodput. For brevity, only the overall cross-section goodput for all the graphs is shown.

The graphs in FIG. 8 show the cross-section goodput made available for single-channel network and for 12-channel/2-nic-per-node network with different channel assignment schemes. Compared with conventional single-channel wireless mesh network architecture 801, the identical channel assignment scheme 802 achieves approximately times improvement in cross-section goodput. In contrast, the neighbor partitioning scheme 803 (as shown in FIG. 4) achieves between 2.5 and 3.5 times improvement over single channel architecture 801. The load-aware channel assignment scheme 804 shows improvement over the neighbor portioning scheme 803 in cross section goodput with just two NICs per node. Intuitively, equipping each wireless mesh network node with multiple interfaces allows the network to use several radio channels simultaneously. This breaks each collision domain into several collision domains operating in a different frequency range. A collision domain is further sub-divided spatially when the ingress-egress node pairs originally passing through the collision domain, take different paths to route the traffic. This division of each collision domain across multiple frequency and spatial domains is the key reason for the nonlinear goodput improvement (eight times) with respect to the increase in the number of NICs (from one to two). Moreover, the interference among adjacent hops of an individual path or among neighboring paths is much reduced.

FIG. 9 shows the same performance comparison when the routing method is changed to randomized multi-path routing. Because no explicit load balancing is performed in multi-path routing method, the performance improvement when going from single-path routing to multiple-path routing is not very consistent. This is true for both the single-channel case and multiple-channel case. However, the goodput gain of the multi-channel network architecture with proper channel assignment algorithms over the conventional single-channel architecture does not seem to depend on a particular routing algorithm. This adaptability of the channel assignment algorithm enables one to choose a routing scheme appropriate to the deployment scenario. The improvement achieved with use of randomization-based multi-path routing is because of better load-balancing of the network. With the use of a more explicit load-balanced routing, the network performance should improve even further.

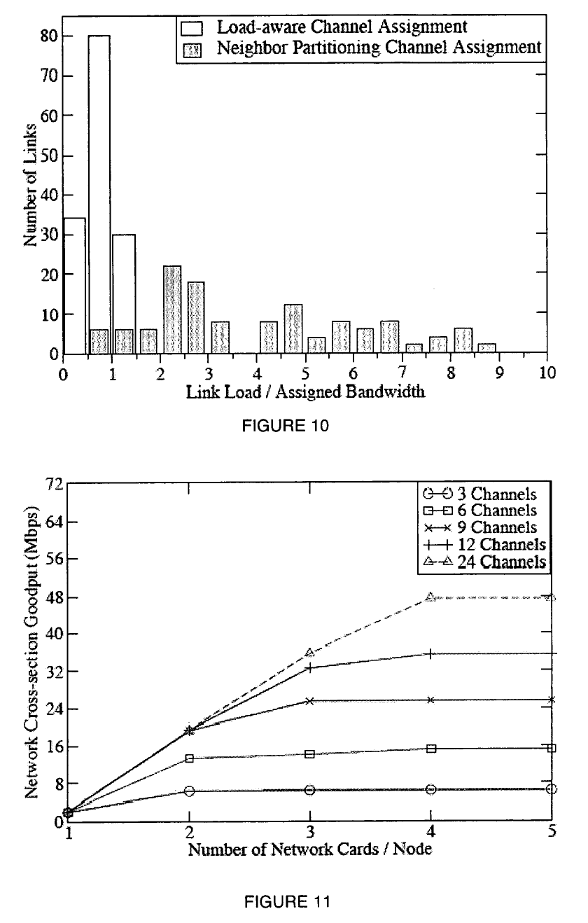

FIG. 10 demonstrates the effectiveness of the channel assignment done by load-aware channel assignment scheme. For each link in the network, the ratio of load imposed by the routing algorithm and the bandwidth assigned by the channel assignment algorithm was measured. A ratio close to one indicates that more bandwidth is allocated to links that require more bandwidth. Observe that although the link load imposed by routing varied anywhere from 0 to 3.9 Mbps across network links, the ratio is close to (or less than) one for the load-aware channel assignment scheme. Achieving this distribution of channel resource among the nodes to match the spatial distribution of traffic load is the key to good performance of the scheme. For the neighbor partitioning scheme, most of the links are overloaded resulting in the variation of ratio from 0.5 to 8.9, the reason is that the latter performs a load-insensitive assignment of channels. The histogram for an identical channel assignment method (not shown) is similar in nature to the Neighbor partitioning approach.

FIG. 11 shows the impact of increasing the number of NICs on each wireless node and/or the number of non-overlapping radio channels available from the physical wireless network technology. The experimental setup for these simulations is the same (10×10 grid-network with 20 pairs of randomly chosen ingress-egress nodes). The number of channels, 3 and 12, correspond to the number of non-overlapping channels available in IEEE 802.11b and 802.11a respectively. The 6 and 9 channels correspond to the cases when some of the wireless channels might be already in use by the access network or some other networks. The experiments demonstrate that the load-aware channel assignment method can effectively adapt itself with the number of available channels/NICs. As new channels become available, the method can increase the reuse distance and thus increase the cross-section goodput. The graphs suggest that increasing the NICs on each node do not help as much as increasing the channels in the network. The reason is that even with two NICs the network is able to span around nine channels, thus the channel limitation comes first. As FCC makes more channels (twelve) available for use by 802.11a, increasing the number of NICs per node beyond three will indeed improve the performance further as shown by the hypothetical graph drawn for twenty-four available channels.

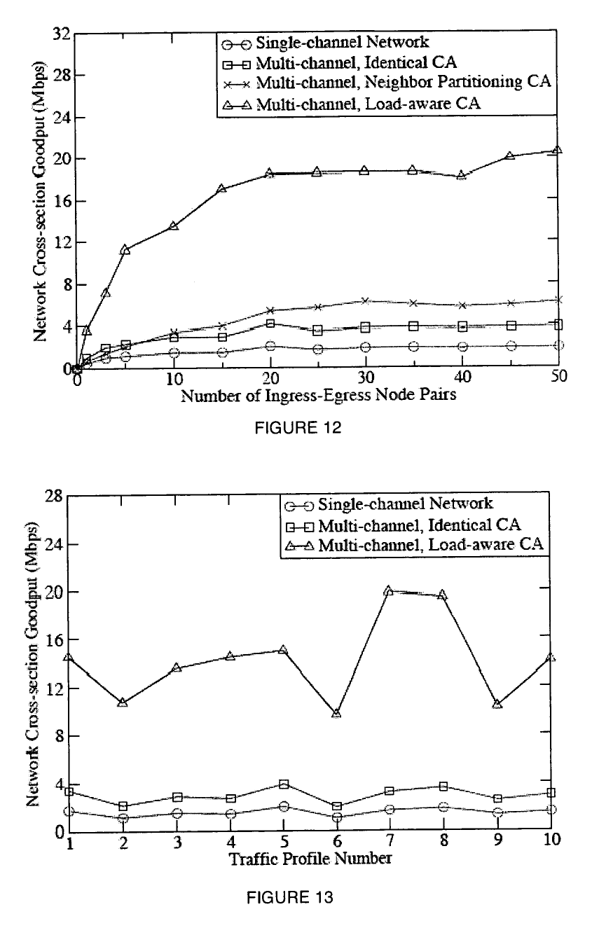

In FIG. 12, the number of ingress-egress pairs in the 10×10 network (each node equipped with two NICs) were varied while keeping the aggregated offered load to be the same. As more ingress-egress pairs are introduced, the traffic needs are more distributed across the network leading to an overall increase in network utilization. The load-aware scheme adapts the channel assignment to these different sets of traffic needs maintaining the performance improvements over single-channel network. Experiments with different traffic profiles produced similar results.

Different network topologies have been experimented with. FIG. 13 shows the performance comparison of the 29-node MIT Roofnet network simulated in NS-2. The data for graph connectivity is based on signal-strength numbers from the testbed. Each point in the graph corresponds to a randomly generated traffic profiles of ten ingress-egress node pairs. The 8+ times improvement in network performance demonstrates the usefulness of multi-channel architecture for real networks. Similar improvements for other topologies—hexagonal grid, and incomplete mesh have been observed. The performance improvement using neighbor partitioning scheme, however, depends on the topology. A more generic way to partition the neighbors is needed in the latter scheme to handle general mesh networks.

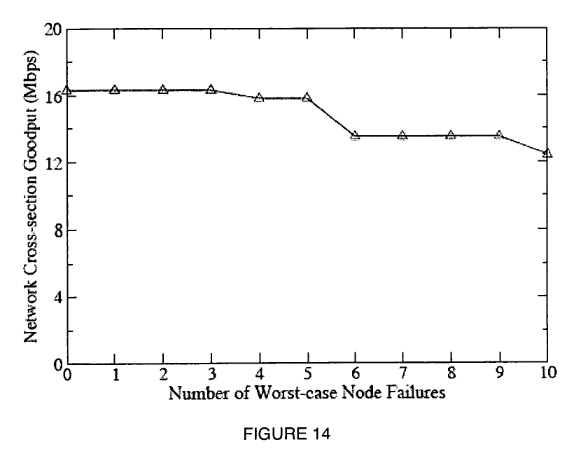

FIG. 14 demonstrates the adaptability of load aware channel assignment to worst-case node failures. Each time after performing the channel assignment and shortest-path routing, the node in the network with the maximum load (and which was not an ingress or egress node) was simulated to fail. The channel assignment process was repeated, and the new crosssection goodput measured. Again, the node with the maximum load was simulated to fail, channel assignment/routing redone, and cross-section goodput measured. The process was repeated for up to 10% node failures. The graceful degradation in network bandwidth indicates the adaptation of channel assignment to node failures. Node failures are probably more random, and therefore bandwidth degradation should be even more graceful. In a practical setting, a routing method may be used that assigns backup paths for communicating node pairs upfront, thus the channel assignment and routing do not need to be done immediately after a node failure. The tremendous improvement in network bandwidth with multichannel architecture makes it possible to allocate such backup paths while maintaining high throughput over primary paths.

For inter-channel interference, a NS-2 simulator makes the assumption that there is no interference between non-overlapping channels. This assumption, however, is not entirely true in practice. Experiments show that with real 802.11b hardware, substantial interference between two cards placed on the same machine despite operating on nonoverlapping channels exists. The extent of interference depends on the relative positions of the cards. Placing cards right on top of each other lead to maximum interference, and achieves only a maximum 20% gain in aggregate goodput over the single channel case (shown in Table 1).

Table 1 illustrates an interference between two internal-antenna equipped 802.11b cards placed on the same machine and operating on channels 1 and 11. The last column indicates the total goodput achieved as a % of sum of individual goodputs without interference. The linklayer data rate for all these experiments was clamped to 11 Mbps.

| NIC-1 | NIC-2 | NIC-1 | NIC-2 | % of Max |
|---|---|---|---|---|
| Action | Action | Goodput | Goodput | Goodput |
| send | silent | 5.52 | — | — |
| recv | silent | 5.23 | — | — |
| silent | send | — | 5.46 | — |
| silent | recv | — | 5.37 | — |
| send | send | 2.44 | 2.77 | 47.6% |
| recv | send | 2.21 | 4.02 | 58.3% |
| send | recv | 4.22 | 2.42 | 61.0% |
| recv | recv | 4.02 | 1.89 | 55.8% |

If the cards are placed horizontally next to each other, as in Orinoco AP-1000 access points, the interference is minimum leading to almost 100% gain in aggregate goodput. In addition, the degradation due to inter-channel interference was found independent of the guard band, i.e. the degradation was almost the same when channel 1 and 6 were used as compared to the case when channel 1 and 11 were used. This interference may arise because of the imperfect frequency-filter present in the commodity cards.

This result has an implication over the placement of multiple cards on the same machine. The electromagnetic leakage from the cards needs to be taken into account, and one card should not be placed in the zone where the strength of the leakage radiations by the other card is high. One possible way to achieve this is to use USB cards instead of PCI/PCMCIA cards and place them side-by-side in similar configuration as in Orinoco AP-1000 access points.

Another possibility is to equip cards with external antennas and place the external antennas slightly away from each other. Using external antennas alone may not suffice: it is also necessary that the internal antenna of the card is disabled. We used Orinoco Gold PCI adapters that come with external antennas that enabled us to build multi-channel wireless mesh network using standard PCs. Table 2 shows the results. The exact interference depends on the placement and card actions (send/receive). The use of external antennas is able to handle most of the interference effects as shown by Table 2; the remaining interference is because of RF leakage from cables and from card's internal components.

Table 2 shows reduced interference with the use of external antennas. Here, the cards were operated on closer channels—1 and 6.

| NIC-1 | NIC-2 | NIC-1 | NIC-2 | % of Max |
|---|---|---|---|---|
| Action | Action | Goodput | Goodput | Goodput |
| send | silent | 5.93 | — | — |
| recv | silent | 5.75 | — | — |
| silent | send | — | 5.96 | — |
| silent | recv | — | 5.78 | — |
| send | send | 5.52 | 5.96 | 96.6% |
| recv | send | 5.37 | 5.89 | 96.2% |
| send | recv | 5.42 | 5.41 | 92.5% |
| recv | recv | 5.66 | 5.17 | 93.9% |

Yet another option is to use the upcoming Engim chipsets, which solve the interference problem at RF-level itself. Engim chipsets receive the complete spectrum, digitize it and process it to compensate for inter-channel interference. This wideband spectral processing capability can help build single NIC with multi-channel communication capability while introducing minimal inter-channel interference.

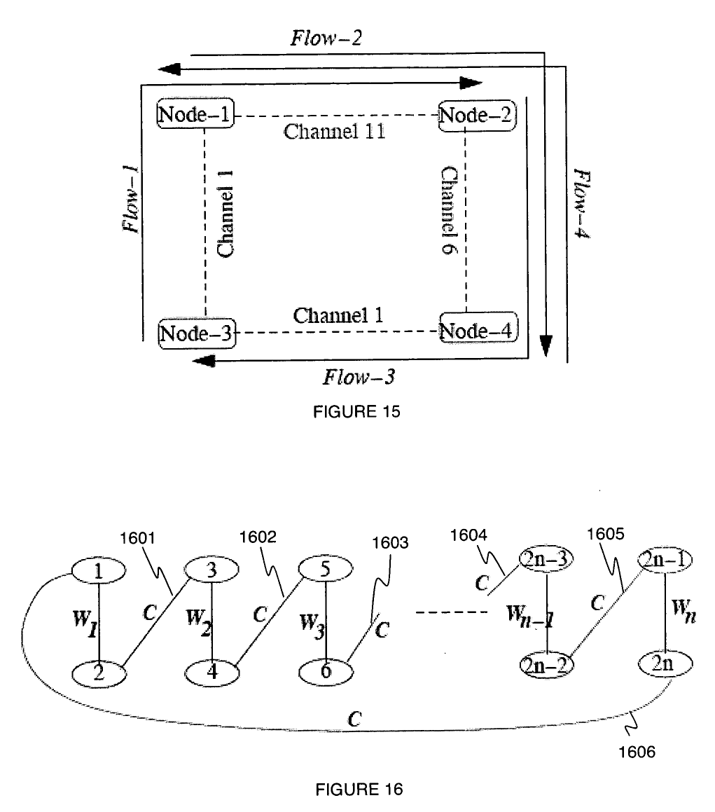

FIG. 15 shows a 4-node multi-channel testbed. Node-1 and node-2 were based on desktops each equipped with one Orinoco 802.11b PCI card and another Cisco Aironet 350 PCMCIA card added using a PCI-PCMCIA convertor. Node3 and node-4 were based on laptops each equipped with one Cisco Aironet 350 PCMCIA card and another Syntax 802.11b USB card. The nodes were arranged in a grid topology as shown in FIG. 15, and four different flows (each going over 2-hops) were generated. The assignment of channels and the routes for the flows were determined using a load-aware channel assignment method. The experiments were then repeated with using only one card on each node tuned to the same channel. Table 3 shows the bandwidth achieved by each flow in the two cases. The multi-channel network achieves 2.63 times the throughput as compared to the singlechannel network. The number of non-overlapping channels in 802.11b standard, i.e. 3, is the limiting factor for this performance. The performance however does not reach 3-times the single-channel network performance because of the inter-channel interference that could not be completely eliminated.

Table 3 shows the performance of a multi-channel 802.11b testbed. The performance improvement in this case is limited by the number of non-overlapping available channels for 802.11b standard.

| | Single-channel | Multi-channel |
|---|---|---|
| Flow Id | 802.11b | 802.11b |
| 1 | 0.92 | 2.40 |
| 2 | 0.70 | 1.61 |
| 3 | 0.87 | 2.40 |
| 4 | 0.85 | 2.39 |
| Total | 3.34 | 8.80 |

Despite many advances in wireless physical-layer technologies, limited bandwidth remains a pressing issue for wireless LANs. The bandwidth issue is most severe for multi-hop wireless mesh networks due to interference among successive hops of an individual path as well as among neighboring paths. As a result, conventional single-channel wireless mesh networks cannot adequately fulfill the role of an extended last-mile access network, let alone a wireless campus backbone that completely replaces wired Ethernet. A multi-channel wireless mesh network architecture based on 802.11 hardware effectively addresses this bandwidth problem, and with proper channel assignment and routing methods such a network architecture may be employed in large networks, such as for a campus-scale backbone network.

Channel assignment plays an important role in realizing the potential of a multi-channel wireless mesh network architecture according to an embodiment of the present disclosure. Channel allocation methods according to an embodiment of the present disclosure may be used in conjunction with different routing algorithms, e.g., shortest path routing and randomized multi-path routing. By deploying just two NICs per node, it is possible to achieve a factor of up to eight improvement in the overall network goodput when compared with a single-NIC-per-node wireless ad hoc network, which is inherently limited to one single radio channel. It has been empirically showed that it is possible to build a PC-based multi-NIC wireless mesh network node with the use of external antennas.

As mentioned, channel assignment is NP-hard; Given the expected load ei on each virtual link i, the goal of channel assignment method is to assign a channel to each network interface, such that the resulting available bandwidth bᵢ on each virtual link is at least equal to its expected load eᵢ. There are physical channels each with a capacity of Q each in any given interference zone. Each node is equipped with k wireless network interfaces.

The NP-hardness of the channel assignment problem can be shown by reducing the Multiple Subset Sum Problem to the channel assignment problem. The multiple subset sum problem can be stated as follows. A set of n items with weights W₁, W₂, Wᵢ, . . . , Wₙ, and m identical bins of capacity C each are given. The objective is to pack these items in the bins such that the total weight of items in the bins is maximized.

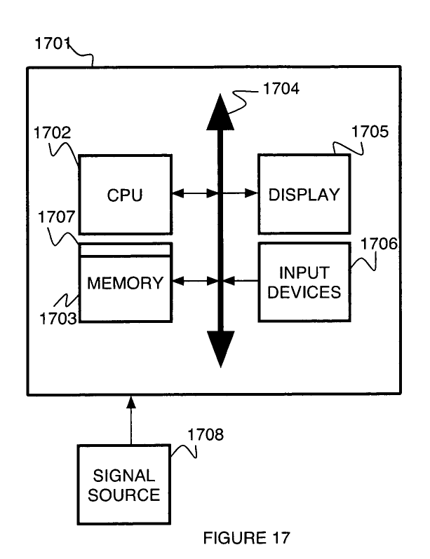

An instance of multiple subset sum problem is converted into an equivalent instance of channel assignment problem as follows. A single collision domain network of 2+n nodes is constructed where each node is equipped with 2 network cards. A virtual link is added between nodes 1 and 2 with bandwidth requirement of W₁ which is the weight of the first item in the given multiple subset problem. Another virtual link is added between nodes 3 and 4 with bandwidth requirement of W₂, and so on. Virtual links between nodes 2 and 3, nodes 4 and 5, and so on are introduced, each with bandwidth requirement of C. A link between is added nodes 2n back to 1. The construction is shown in FIG. 16. The capacity of the channel is the same as the bin capacity C, and the number of channels is equal to m+n.

For a solution to this constructed problem; each of the links 1601-1606 with bandwidth requirement C has to be assigned over a dedicated channel. Thus, the solution needs to use the remaining m channels to satisfy all the black links. Each link 1601-1606 also uses two network interfaces—one on each of the two nodes it is incident upon. Thus, the solution must use the remaining single interface on each node to satisfy the black links bandwidth requirements.

Now, all the links Wₓ_{₁}, . . . Wₓ_{₂}, . . . , Wₓ_{_{P}} that the solution puts over any one of the m channels must have a sum less than C. This means, that for the original multiple subset problem, all of x₁, x₂, . . . , wₚ can go into one bin. Similarly, all the items corresponding to virtual links scheduled over any other channel can go to the corresponding bin. Thus, if the channel assignment problem were solvable in polynomial time, so would be the multiple subset sum problem. Since the multiple subset sum problem is NP-hard, the channel assignment problem is also NP-hard.

Referring to FIG. 17, according to an embodiment of the present invention, a computer system 1701 for implementing the present invention can comprise, inter alia, a central processing unit (CPU) 1702, a memory 1703 and an input/output (I/O) interface 1704. The computer system 1701 is generally coupled through the I/O interface 1704 to a display 1705 and various input devices 1706 such as a mouse and keyboard. The support circuits can include circuits such as cache, power supplies, clock circuits, and a communications bus. The memory 1703 can include random access memory (RAM), read only memory (ROM), disk drive, tape drive, etc., or a combination thereof. The present invention can be implemented as a routine 1707 that is stored in memory 1703 and executed by the CPU 1702 to process the signal from the signal source 1708. As such, the computer system 1701 is a general purpose computer system that becomes a specific purpose computer system when executing the routine 1707 of the present invention.

The computer platform 1701 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

Having described embodiments for a system and method for channel assignment and routing for a wireless mesh network, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. A method for channel assignment in a wireless network comprising:
estimating an expected load on each link of the wireless network, each link being between a node pair in the wireless network;
determining a channel assignment between each node pair in the wireless network such that a bandwidth made available to each virtual link is at least the expected load;
determining an actual link capacity given the channel assignment; and
modifying the channel assignment according to the actual link capacity.

2. The method of claim 1, further comprising estimating a traffic load for all ingress-egress node pairs of the wireless network.

3. The method of claim 1, further comprising determining a topology of the wireless network.

4. The method of claim 1, further comprising determining a number of network interfaces available to each node of the wireless network.

5. The method of claim 1, further comprising determining a number of non-over lapping channels.

6. The method of claim 1, wherein the channel assignment between nodes binds an interface of the each node to the channel.

7. The method of claim 1, further comprising determining a set of paths for each node pair in the wireless network, wherein the wireless network is a mesh network.

8. A method for channel assignment in a wireless network comprising:
determining a channel/route configuration comprising channel assignments and routing information for a plurality of nodes of the wireless network providing a desired initial network cross-section throughput;
determining a link capacity for each link between a plurality of node pairs of the plurality of nodes; and
modifying the route information of the channel/route configuration according to the link capacity.

9. The method of claim 8, wherein determining the channel/route configuration comprises:
determining the channel assignment for each link between node pairs, an initial channel assignment being determined without link capacity information;
determining a link capacity for each link;
determining the routing information according to the link capacities;
outputting expected link loads for each link; and
interating through the determinations of the channel assignment and routing information until link capacity is at least equal to the expect link load for each link.

10. The method of claim 9, wherein the initial channel assignment assumes that interfering links within a neighborhood equally split the bandwidth of a plurality of available radio channels.

11. The method of claim 8, wherein modifying the route information of the channel/route configuration according to the link capacity comprises:
determining routes that have a link capacity less than an expected link load; and
modifying the routes that have the link capacity less than the expected link load to at least lessen the difference between the link capacity and the expected link load.

12. The method of claim 8, further comprising determining a fixed routing order prior to determining a first determining a channel/route configuration.

13. The method of claim 12, wherein the routing order specifies that routes having a shorter hopcount between end-point nodes are modified before routes having a longer hopcount between end-point nodes.

14. The method of claim 8, wherein the network cross-section throughput is a measure of goodput.

15. A program storage device readable by machine, tangibly embodying a program of instructions executable by the machine to perform method steps for channel assignment in a wireless network, the method steps comprising:
determining a channel/route configuration comprising channel assignments and routing information for a plurality of nodes of the wireless network providing a desired initial network cross-section throughput;
determining a link capacity for each link between a plurality of node pairs of the plurality of nodes; and
modifying the route information of the channel/route configuration according to the link capacity.

16. The method of claim 15, wherein determining the channel/route configuration comprises:
determining the channel assignment for each link between node pairs, an initial channel assignment being determined without link capacity information;
determining a link capacity for each link;
determining the routing information according to the link capacities;
outputting expected link loads for each link; and
interating through the determinations of the channel assignment and routing information until link capacity is at least equal to the expect link load for each link.

17. The method of claim 16, wherein the initial channel assignment assumes that interfering links within a neighborhood equally split the bandwidth of a plurality of available radio channels.

18. The method of claim 15, wherein modifying the route information of the channel/route configuration according to the link capacity comprises:
determining routes that have a link capacity less than an expected link load; and
modifying the routes that have the link capacity less than the expected link load to at least lessen the difference between the link capacity and the expected link load.
